(19) United States
(12) Patent Application Publication
(10) Pub. No.: US 2021/0227087 A1
(43) Pub. Date: Jul. 22, 2021

(54) AUTHENTICATION APPARATUS, AUTHENTICATION SYSTEM, IMAGE PROCESSING SYSTEM, AND AUTHENTICATION METHOD

(71) Applicants: Tatsuya OZAKI, Kanagawa (JP); Tadaaki OYAMA, Kanagawa (JP); Masamoto NAKAZAWA, Kanagawa (JP); Yutaka OHMIYA, Tokyo (JP)

(72) Inventors: Tatsuya OZAKI, Kanagawa (JP); Tadaaki OYAMA, Kanagawa (JP); Masamoto NAKAZAWA, Kanagawa (JP); Yutaka OHMIYA, Tokyo (JP)

(73) Assignee: Ricoh Company, Ltd.

(21) Appl. No.: 16/952,103

(22) Filed: Nov. 19, 2020

(30) Foreign Application Priority Data
Jan. 21, 2020 (JP) 2020-007806

(51) Int. Cl. H04N 1/00

(52) U.S. Cl. CPC H04N 1/00854; H04N 1/00037

(57) ABSTRACT

An authentication apparatus includes circuitry that selects at least one of a first light emitting device and a second light emitting device. The first light emitting device emits light in a certain wavelength region. The second light emitting device emits light in a wavelength region different from the certain wavelength region of the light emitted from the first light emitting device. The circuitry further reads embedded information based on a reading result obtained in an imaging device that receives the light emitted from the selected at least one of the first light emitting device and the second light emitting device and reflected by an authentication medium. The embedded information includes information for authentication, and is embedded in the authentication medium and obtained with light in a range of light receiving sensitivity of silicon forming the imaging device.

### CROSS-REFERENCE TO RELATED APPLICATION

This patent application is based on and claims priority pursuant to 35 U.S.C. § 119(a) to Japanese Patent Application No. 2020-007806 filed on Jan. 21, 2020 in the Japan Patent Office, the entire disclosure of which is hereby incorporated by reference herein.

### BACKGROUND

### Technical Field

The present invention relates to an authentication apparatus, an authentication system, an image processing system, and an authentication method.

### Description of the Related Art

Documents (e.g., forms) including valuable prints such as bank notes and certificates for authenticating individuals such as licenses and certificates of residence are expected to be constantly protected by new anti-forgery techniques to prevent the documents from being forged or altered by a third party. Further, there is a demand for an authenticity determination method capable of determining the authenticity of the documents such as valuable prints and certificates.

There is a technique of authenticating a concealment pattern printed with infrared (IR) black ink and determining a pattern printed with another medium as a forgery. For example, according to an existing technique, an information code covered with a concealment pattern is read with two types of light each having a certain wavelength, and the reflectance of each of images read with the two types of light is compared with a threshold value to determine the authenticity of the information code.

According to the above-described technique, however, the information code covered with the concealment pattern is read with two types of light from a light source in the IR region and a light source in the visible region and the IR region. Consequently, the technique degrades the reproducibility (e.g., density and color) and visibility of the document.

Further, if one of the two types of light is limited to the light in the visible region, the technique may fail to detect a forgery depending on the type of ink used in the forgery, and thus may hinder the improvement of the security level.

### SUMMARY

In one embodiment of this invention, there is provided an improved authentication apparatus that includes, for example, circuitry that selects at least one of a first light emitting device and a second light emitting device. The first light emitting device emits light in a certain wavelength region. The second light emitting device emits light in a wavelength region different from the certain wavelength region of the light emitted from the first light emitting device. The circuitry further reads embedded information based on a reading result obtained in an imaging device that receives the light emitted from the selected at least one of the first light emitting device and the second light emitting device and reflected by an authentication medium. The embedded information includes information for authentication, and is embedded in the authentication medium and obtained with light in a range of light receiving sensitivity of silicon forming the imaging device.

In one embodiment of this invention, there is provided an improved authentication system that includes, for example, a first light emitting device, a second light emitting device, and circuitry. The first light emitting device emits light in a certain wavelength region. The second light emitting device emits light in a wavelength region different from the certain wavelength region of the light emitted from the first light emitting device. The circuitry selects at least one of the first light emitting device and the second light emitting device. The circuitry further reads embedded information based on a reading result obtained in an imaging device that receives the light emitted from the selected at least one of the first light emitting device and the second light emitting device and reflected by an authentication medium. The embedded information includes information for authentication, and is embedded in the authentication medium and obtained with light in a range of light receiving sensitivity of silicon forming the imaging device.

In one embodiment of this invention, there is provided an improved image processing system that includes, for example, a first light emitting device, a second light emitting device, an imaging device, and the above-described authentication apparatus. The first light emitting device emits light in a certain wavelength region. The second light emitting device emits light in a wavelength region different from the certain wavelength region of the light emitted from the first light emitting device. The imaging device receives light reflected by an authentication medium.

In one embodiment of this invention, there is provided an improved image processing system that includes, for example, an imaging device and the above-described authentication system. The imaging device receives light reflected by an authentication medium.

In one embodiment of this invention, there is provided an improved authentication method that includes, for example, selecting at least one of a first light emitting device and a second light emitting device, and reading embedded information based on a reading result obtained in an imaging device. The first light emitting device emits light in a certain wavelength region. The second light emitting device emits light in a wavelength region different from the certain wavelength region of the light emitted from the first light emitting device. The imaging device receives the light emitted from the selected at least one of the first light emitting device and the second light emitting device and reflected from an authentication medium. The embedded information includes information for authentication, and is embedded in the authentication medium and obtained with light in a range of light receiving sensitivity of silicon forming the imaging device.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an exemplary configuration of an image processing apparatus of a first embodiment of the present invention;

FIG. 2 is a cross-sectional view illustrating an exemplary structure of an image reading device in the image processing apparatus of the first embodiment;

FIG. 3 is a block diagram illustrating electrical connection of components forming the image reading device of the first embodiment;

FIG. 4 is a diagram illustrating a range of light receiving sensitivity of silicon;

FIG. 5 is a block diagram illustrating a functional configuration of the image reading device of the first embodiment;

FIGS. 6A, 6B, 6C, and 6D are diagrams illustrating an example of changes in a reading result with respect to the percentage of infrared wavelength components contained in a light source;

FIG. 7 is a diagram illustrating an example of a form including a print pattern of the first embodiment using two types of toner;

FIGS. 8A, 8B, 8C, and 8D are diagrams illustrating a reading example of the print pattern of the first embodiment using two types of toner;

FIG. 9 is a diagram illustrating an example of the first embodiment in which information for identifying an individual is used as authentication information;

FIGS. 10A, 10B, and 10C are diagrams illustrating examples of the first embodiment to set a password as the authentication information;

FIG. 11 is a diagram illustrating a method of the first embodiment to generate the authentication information from biometric information and execute authentication;

FIGS. 12A and 12B are diagrams illustrating a document authentication method of the first embodiment using embedding of information leading to an authentication process;

FIGS. 13A, 13B, 13C, and 13D are diagrams illustrating a first modified example of a combination rule of the first embodiment;

FIGS. 14A, 14B, 14C, and 14D are diagrams illustrating a second modified example of the combination rule of the first embodiment;

FIGS. 15A, 15B, 15C, and 15D are diagrams illustrating a third modified example of the combination rule of the first embodiment;

FIGS. 16A, 16B, 16C, and 16D are diagrams illustrating a fourth modified example of the combination rule of the first embodiment;

FIGS. 17A, 17B, 17C, and 17D are diagrams illustrating a reading example of a print pattern of a second embodiment of the present invention using three types of toner;

FIGS. 18A, 18B, 18C, and 18D are diagrams illustrating an example of simultaneous reading of the second embodiment using visible light and invisible light;

FIGS. 19A, 19B, 19C, and 19D are diagrams illustrating an example of using a three-color pattern in the simultaneous reading of the second embodiment using the visible light and the invisible light;

FIG. 20 is a diagram illustrating an example of a form including dummy information of a third embodiment of the present invention;

FIG. 21 is a flowchart illustrating a procedure of an authentication process of the third embodiment using the dummy information;

FIG. 22 is a diagram illustrating a display example of an error screen of the third embodiment; and

FIGS. 23A, 23B, 23C, and 23D are diagrams illustrating a reading example of a print pattern of a fourth embodiment of the present invention.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of an authentication apparatus, an authentication system, an image processing system, and an authentication method of the present invention will be described in detail below with reference to the accompanying drawings.

A first embodiment of the present invention will be described.

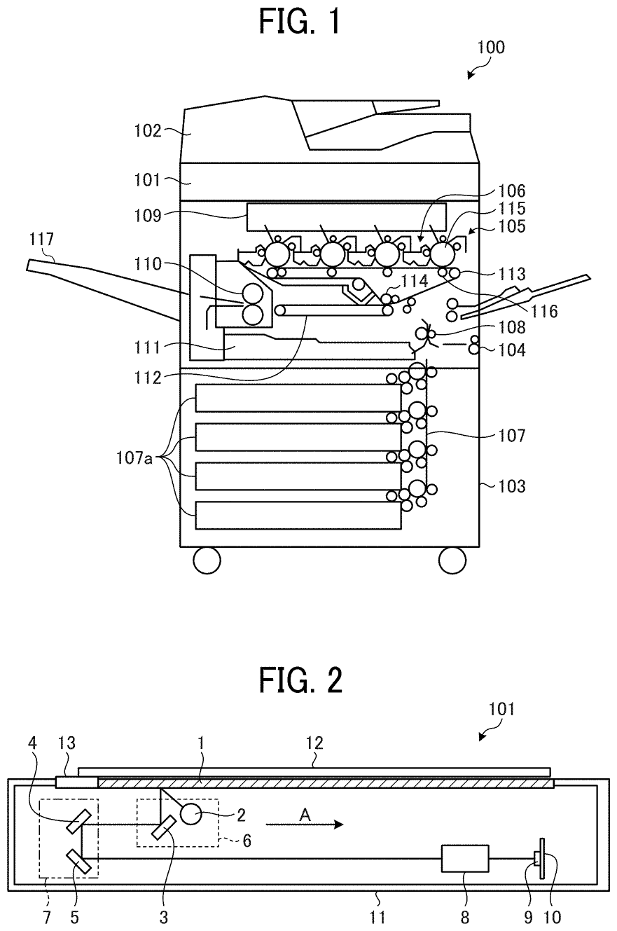

FIG. 1 is a diagram illustrating an exemplary configuration of an image processing apparatus 100 of the first embodiment. In FIG. 1, the image processing apparatus 100 (i.e., an image processing system) functions as an authentication apparatus (i.e., an authentication system). The image processing apparatus 100 is an image forming apparatus typically called multifunction peripheral (MFP) and having at least two functions out of a copier function, a printer function, a scanner function, and a facsimile machine function.

The image processing apparatus 100 includes an image reading device 101, an automatic document feeder (ADF) 102, and an image forming device 103 disposed under the image reading device 101 and the ADF 102. To illustrate an internal configuration of the image forming device 103, FIG. 1 illustrates the image forming device 103 with an outer cover thereof removed therefrom.

The ADF 102 is a document support device that positions a document, the image of which is to be read, at a reading position. The ADF 102 automatically transports the document placed on a document placement table to a predetermined reading position.

At the predetermined reading position, the image reading device 101 reads the document transported by the ADF 102. An upper surface of the image reading device 101 is equipped with a contact glass, which serves as a document support portion on which a document is placed. The image reading device 101 further reads the document placed on the contact glass. In this case, the reading position corresponds to the position of the contact glass. Specifically, the image reading device 101 is a scanner including therein a light source, an optical system, and a photoelectric converter such as a charge coupled device (CCD). Through the optical system, the image reading device 101 reads light reflected by the document illuminated by the light source.

The image forming device 103 prints the image of the document read by the image reading device 101. The image forming device 103 includes a manual feeding roller 104 for manually feeding a recording sheet and a recording sheet supplying device 107 that supplies a recording sheet. The recording sheet supplying device 107 has a mechanism that sends a recording sheet out of one of multiple recording sheet feeding cassettes 107a. The supplied recording sheet is sent to a second transfer belt 112 via a registration roller 108.

The recording sheet is transported on the second transfer belt 112, and toner images formed on an intermediate transfer belt 113 are transferred onto the recording sheet on the second transfer belt 112 by a second transfer device 114.

The image forming device 103 further includes an optical writing device 109, an image forming unit 105, the second transfer belt 112, and the intermediate transfer belt 113, for example. The image forming unit 105 is a tandem system including four photoconductor drums 115 for forming yellow (Y), magenta (M), cyan (C), and black (K) toner images. The optical writing device 109 writes latent images on the photoconductor drums 115. The latent images are then developed into toner images through an image forming process performed by the image forming unit 105, and are transferred onto the intermediate transfer belt 113.

Specifically, the image forming unit 105 includes the four rotatable photoconductor drums 115, which correspond to the Y, M, C, and K colors, respectively. Each of the photoconductor drums 115 is surrounded by image forming components 106, which include a charging roller, a developing device, a first transfer roller 116, a cleaner device, and a discharging device. With the image forming components 106 operating around the photoconductor drums 115, the toner images formed on the photoconductor drums 115 are first-transferred onto the intermediate transfer belt 113 by the respective first transfer rollers 116.

The intermediate transfer belt 113 is stretched by a drive roller and a driven roller to pass through respective nips formed between the photoconductor drums 115 and the first transfer rollers 116. With the rotation of the intermediate transfer belt 113, the toner images first-transferred to the intermediate transfer belt 113 are second-transferred onto the recording sheet on the second transfer belt 112 by the second transfer device 114. With the rotation of the second transfer belt 112, the recording sheet is then transported to a fixing device 110, in which the toner images are fixed on the recording sheet as a color image. Then, the recording sheet is ejected to a sheet ejection tray 117 outside a main body of the image processing apparatus 100. In duplex printing, the recording sheet is reversed by a sheet reversing mechanism 111, and the reversed recording sheet is sent back to the second transfer belt 112.

The image formation by the image forming device 103 is not limited to the above-described electrophotographic image formation, and the image forming device 103 may form an image with the inkjet method.

The image reading device 101 will be described in more detail.

FIG. 2 is a cross-sectional view illustrating an exemplary structure of the image reading device 101. As illustrated in FIG. 2, the image reading device 101 includes, in a main body 11 thereof, a sensor board 10 equipped with a photoelectric converter 9, a lens unit 8, a first carriage 6, and a second carriage 7. The photoelectric converter 9 is an imaging device such as a CCD or complementary metal oxide semiconductor (CMOS) image sensor, for example. The first carriage 6 includes a minor 3 and a light source 2, which is implemented by a light emitting diode (LED). The second carriage 7 includes minors 4 and 5. Further, the upper surface of the image reading device 101 is equipped with a contact glass 1 and a white reference plate 13.

In a reading operation, the image reading device 101 emits light upward from the light source 2 while moving the first carriage 6 and the second carriage 7 in a sub-scanning direction A from a standby position (i.e., home position). Then, the first carriage 6 and the second carriage 7 direct the light reflected by a document 12 to the photoelectric converter 9 via the lens device 8, to thereby form an image on the photoelectric converter 9.

When the image processing apparatus 100 is powered on, for example, the image reading device 101 sets a reference value by reading the light reflected by the white reference plate 13. That is, the image reading device 101 moves the first carriage 6 to a position immediately under the white reference plate 13, turns on the light source 2, and directs the light reflected by the white reference plate 13 to the photoelectric converter 9 to form an image thereon, to thereby perform gain adjustment.

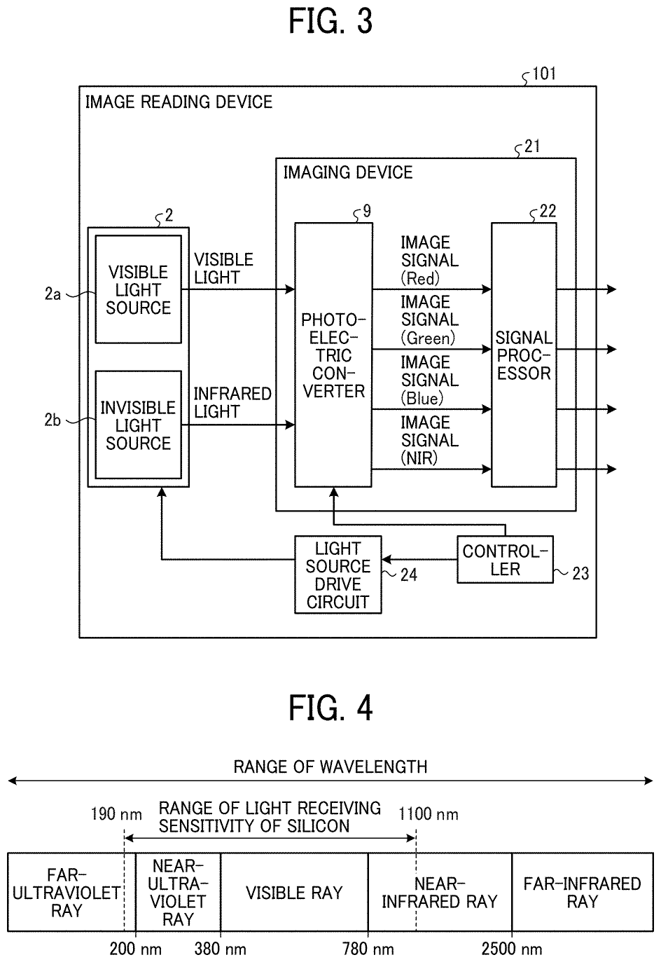

FIG. 3 is a block diagram illustrating electrical connection of components forming the image reading device 101. As illustrated in FIG. 3, the image reading device 101 includes the light sources 2, an imaging device 21, a controller 23, and a light source drive circuit 24 that drives the light source 2.

The light source 2 includes a visible light source 2a (an example of a first light emitting device) and an invisible light source 2b (an example of a second light emitting device). The visible light source 2a emits visible light with a wavelength mostly in the visible region (e.g., red, green, and blue light). The invisible light source 2b emits invisible light with a wavelength in the near-infrared (NIR) region (i.e., NIR light). More specifically, the visible light source 2a emits light that has a wavelength mostly in the visible region and contains infrared (IR) wavelength components by an amount not hindering the readability of document information obtained by reading light with an IR wavelength.

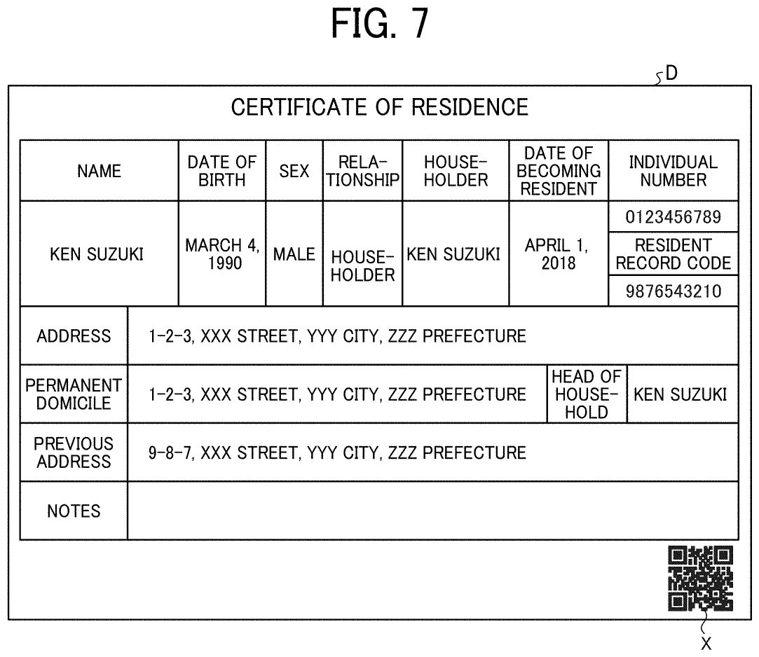

The amount of IR wavelength components contained in the light emitted from the visible light source 2a is negligible in terms of the influence of light with an NIR wavelength. In reading a document (e.g., form) such as a form D in FIG. 7, therefore, the image reading device 101 ensures readability and security strength with the visible light source 2a and the invisible light source 2b, respectively. The document (e.g., form) is an example of an authentication medium.

There is a technique of using ultraviolet (UV) light source for image reading. However, a type of glass typically used as a material of an optical component absorbs a substantial amount of light in the UV wavelength region. It is therefore difficult to handle the light in the UV wavelength region with an optical component such as a typical lens, and thus a special reading device is used in image reading in the UV wavelength region. Further, due to the harmful effects of UV light on the human body, the handling of UV light in a typical office environment entails risk.

There is also a technique of using light with a wavelength in the IR region as a first light source and using light with a wavelength ranging from the visible region to the IR region as a second light source. According to this technique, however, the first light source and the second light source both have a wavelength in the IR region, consequently degrading the reproducibility and visibility of the document.

FIG. 4 is a diagram illustrating a range of light receiving sensitivity of silicon. As illustrated in FIG. 4, the light receiving sensitivity of silicon normally ranges from a wavelength of 190 nanometers (nm) in the UV region to a wavelength of 1100 nm in the NIR region. Using light with a wavelength in this range as a light source (i.e., an NIR light source) enables imaging with a typical silicon photodiode. It is therefore unnecessary to prepare a special reading device to read the light emitted from the NIR light source, enabling imaging with an image sensor of a scanner included in a typical MFP. Further, the NIR light source does not cause harm to the human body, and thus is applicable with relative ease in terms of risk to the human body.

Referring back to FIG. 3, the imaging device 21 includes the photoelectric converter 9 and a signal processor 22. The photoelectric converter 9 is capable of imaging the light in the visible region and the light in the invisible region. The photoelectric converter 9 receives the visible light (e.g., red, green, and blue light) and the invisible light (e.g., IR light) divided from incident light by color filters, for example, depending on the wavelength of the light, and converts the visible light and the invisible light into red (R), green (G), blue (B), and NIR electrical signals. For a plurality of systems, the photoelectric converter 9 simultaneously outputs R, G, and B image signals to the subsequent signal processor 22 in the reading of a visible image, and simultaneously outputs an NIR image signal to the signal processor 22 in the reading of an invisible image.

In the present embodiment, a description will be given of an example in which an NIR image is used as the invisible image. However, the wavelength region used in the invisible image is not limited to a particular wavelength region. Further, the image used in the present embodiment may be limited to the visible image.

The controller 23 controls the light source drive circuit 24, the photoelectric converter 9, and the signal processor 22. The controller 23 is implemented by a control circuit such as a central processing unit (CPU) or an application specific integrated circuit (ASIC). The signal processor 22 executes various types of signal processing on the image signals output from the photoelectric converter 9.

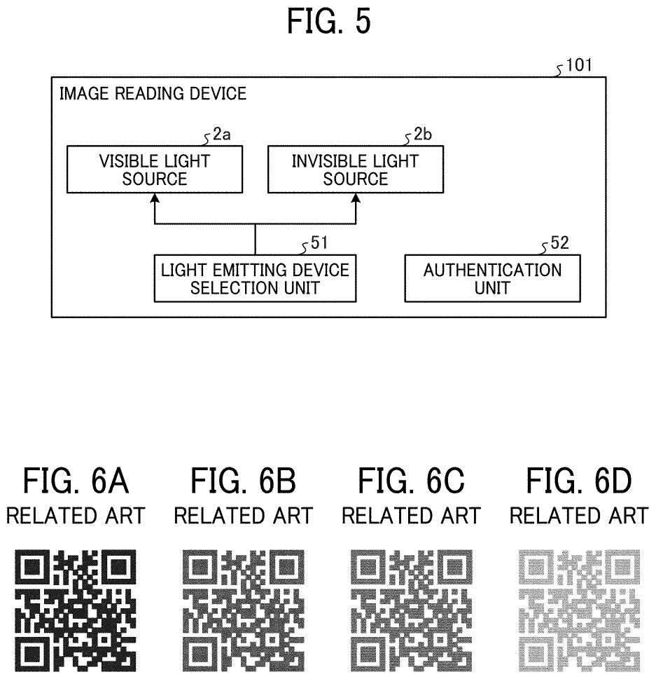

FIG. 5 is a block diagram illustrating a functional configuration of the image reading device 101. As illustrated in FIG. 5, the image reading device 101 includes a light emitting device selection unit 51 and an authentication unit 52, which are implemented by the controller 23.

The light emitting device selection unit 51 selects one of the visible light source 2a and the invisible light source 2b. Based on a reading result obtained with the visible light source 2a and a reading result obtained with the invisible light source 2b, the authentication unit 52 reads embedded information to execute an authentication process. The embedded information includes information for authentication, and is embedded in the document (e.g., form) as the authentication medium.

As described above, with an increase of IR wavelength components in a light source, the reproducibility (e.g., density and color) and visibility of the document are substantially degraded. Document data with degraded reproducibility and visibility is undesirable when storing or copying the read document as electronic data for use. Further, if the document contains information such as a quick response (QR) code (registered trademark) or a bar code, a code reader is likely to fail to read the code owing to a reduction in contrast.

FIGS. 6A, 6B, 6C, and 6D are diagrams illustrating an example of changes in the reading result with respect to the percentage of IR wavelength components contained in a light source. FIG. 6A illustrates a reading result obtained when the percentage of visible wavelength components in the light source is 100%, i.e., a reading result representing original information. FIG. 6B illustrates a reading result obtained when the percentage of IR wavelength components in the light source is approximately 10%. FIG. 6C illustrates a reading result obtained when the percentage of IR wavelength components in the light source is approximately 30%. FIG. 6D illustrates a reading result obtained when the percentage of IR wavelength components in the light source is approximately 50%. As illustrated in FIGS. 6A to 6D, with an increase in the percentage of IR wavelength components in the light source, the read image of a high-density area, (e.g., a black area printed with a color material not including carbon black, such as YMC toner) turns out whitish, as illustrated in FIGS. 6C and 6D, for example. Due to the reduction in contrast, therefore, the QR code or the bar code may fail to be properly read.

In the image reading device 101 of the present embodiment, therefore, the light emitting device selection unit 51 selects the visible light source 2a to read a regular document (e.g., form).

Thereby, the reading of the regular document does not involve the degradation in reproducibility or visibility of the document or the deterioration of information included in the document, thereby enabling the read document per se to be stored or copied as electronic data for use.

A description will be given of the reading of information using two types of toner.

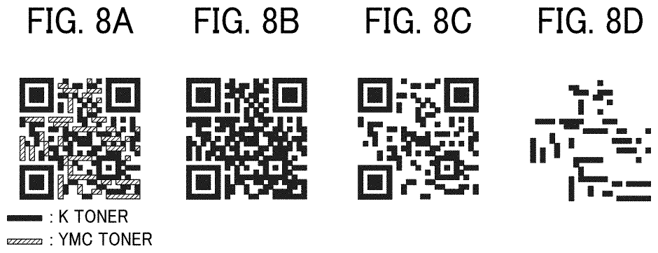

FIG. 7 is a diagram illustrating an example of a form including a print pattern using two types of toner. FIGS. 8A, 8B, 8C, and 8D are diagrams illustrating a reading example of the print pattern using two types of toner. In FIG. 7, the print pattern represents embedded information X printed on a form (i.e., document) D. FIG. 8A illustrates an enlarged view of the print pattern of authentication information illustrated in FIG. 7.

As illustrated in FIG. 7, the authentication information for authentication is printed on the form D as the embedded information X. The embedded information X may be the authentication information directly printed on the form D, or may be the authentication information printed on the form D in a different form such as a QR code, for example. Herein, the embedded information X refers to an image or a character string per se that appears on the form D (e.g., the QR code illustrated in FIG. 7), and the authentication information refers to information for use in authentication (e.g., a password reconstructed from a QR code). The authentication information for authentication may be set to information knowable only to the applicant for issuance of the form D, for example, to enhance the security strength.

A party that receives the form D submitted thereto requests the submitter of the form D to present the authentication information, and compares the presented authentication information with the authentication information embedded in the form D to determine the authenticity of the form D. Even if the form D is forged, therefore, the authenticity of the form D will not be verified by a person other than the applicant for issuance of the form D. Consequently, the security strength is enhanced.

The print area of the authentication information is not limited to a particular area. For example, the authentication information may be visibly printed at the end of the form D, or may be printed in an area in which the information of the form D is printed such that the authentication information blends in the information of the form D.

Although FIGS. 8A to 8D illustrate the QR code for illustration, the actual print pattern is not limited thereto, and may be a two-dimensional code, a character string, or an image pattern, for example.

As illustrated in FIG. 8A, the print pattern is generated with a black pattern using K toner and a black pattern using Y toner, M toner, and C toner (hereinafter collectively referred to as the YMC toner), for example. Herein, each of the patterns using these types of toner is not necessarily required to be an independently meaningful image. That is, the print pattern representing the embedded information X is printed with a combination of a black visible toner (i.e., the K toner) and a visible toner of a certain chromatic color (i.e., the YMC toner). The use of such typical types of toner as the K toner and the YMC toner suppresses an increase in cost and difficulty in the application of the present embodiment.

When a black image printed with the K toner and a black image printed with the YMC toner are acquired in the visible wavelength region, the two black images are both successfully read. When the black image printed with the K toner and the black image printed with the YMC toner are acquired in the invisible wavelength region, on the other hand, the black image printed with the K toner is successfully read, but the black image printed with the YMC toner fails to be read. The information of the YMC toner is obtainable by subtracting image data acquired in the invisible wavelength region from image data acquired in the visible wavelength region.

When reading the embedded information X (i.e., the print pattern) printed with the K toner and the YMC toner, such as the print pattern illustrated in FIG. 8A, therefore, the image reading device 101 of the present embodiment sequentially selects the visible light source 2a and the invisible light source 2b with the light emitting device selection unit 51. With the print pattern thus read in the visible light condition and the invisible light condition, respectively, the image illustrated in FIG. 8B and the image illustrated in FIG. 8C are read. FIG. 8B illustrates a pattern read with the visible light source 2a. FIG. 8C illustrates a pattern read with the invisible light source 2b.

These two images are then combined in accordance with a certain rule, as illustrated in FIG. 8D. In the example illustrated in FIG. 8D, the image is obtained by subtracting the image data read with the invisible light source 2b from the image data read with the visible light source 2a. The thus-obtained image is used as the authentication information.

That is, the party that receives the form D reads the embedded information X printed on the form D, generates the authentication information in accordance with a certain rule, and compares the generated authentication information with the authentication information presented by the submitter of the form D, to thereby determine the authenticity of the submitted form D.

As described above, the embedded information X printed with the combination of the K toner and the YMC toner for authenticity determination is read in certain reading conditions (e.g., a reading condition using the visible light and a reading condition using the invisible light). In the reading with the invisible light, the light in the IR region is read. Due to a difference in absorption characteristics in the IR region between the K toner and the YMC toner, the reading result is different between the visible region and the IR region and between the K toner and the YMC toner.

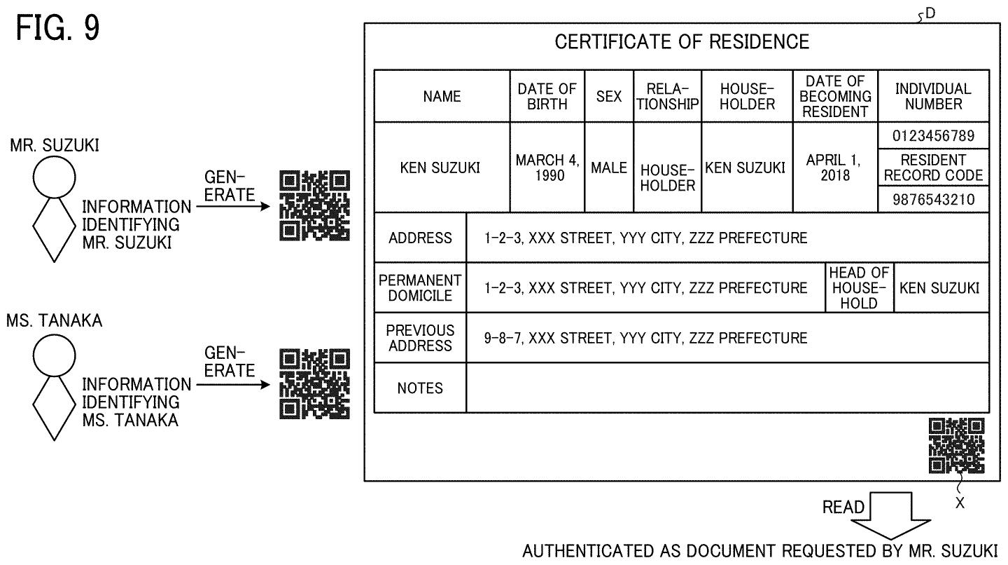

FIG. 9 is a diagram illustrating an example in which information for identifying an individual is used as the authentication information. In the present embodiment, the information for identifying an individual is used as the authentication information for authentication, as illustrated in FIG. 9. The information for identifying an individual may be any information capable of identifying the applicant for issuance of the form D as a particular person. For example, in the example of FIG. 9, each of information capable of identifying Mr. Suzuki and information capable of identifying Ms. Tanaka is embedded in the form D as the embedded information X. The party that receives the form D reads the information for identifying an individual, and determines whether the submitter of the form D is the actual applicant for issuance of the form D. For example, the party that receives the form D reads the embedded information X to determine whether the submitted form D is the form D requested by Mr. Suzuki, for instance.

Even if the form D is submitted by someone who has illegally obtained the form D by stealing or unauthorized copying, for example, the party that receives the form D may refuse to accept the submitted form D or may request the submitter of the form D to submit a reissued form D when the submitter of the form D is not identified as the applicant for issuance of the form D. Thereby, the abuse of the form D is prevented.

That is, the information for identifying the applicant for issuance of the form D is previously set and embedded in the form D as the embedded information X. The embedded information X is then used for authentication, thereby enhancing the security strength.

Further, a password previously set by the applicant for issuance of the form D at the time of issuance of the form D may be embedded in the form D as the embedded information X to be used as the authentication information for authentication.

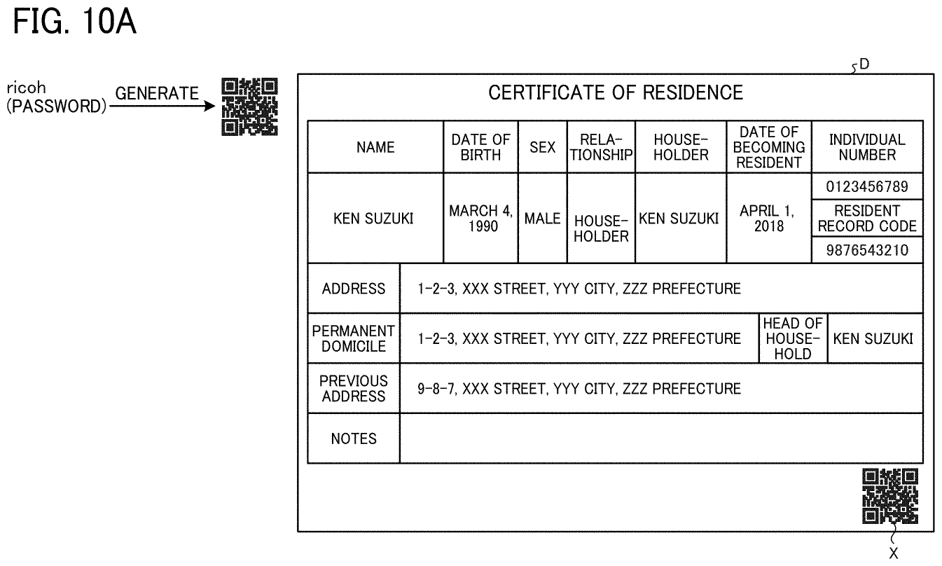

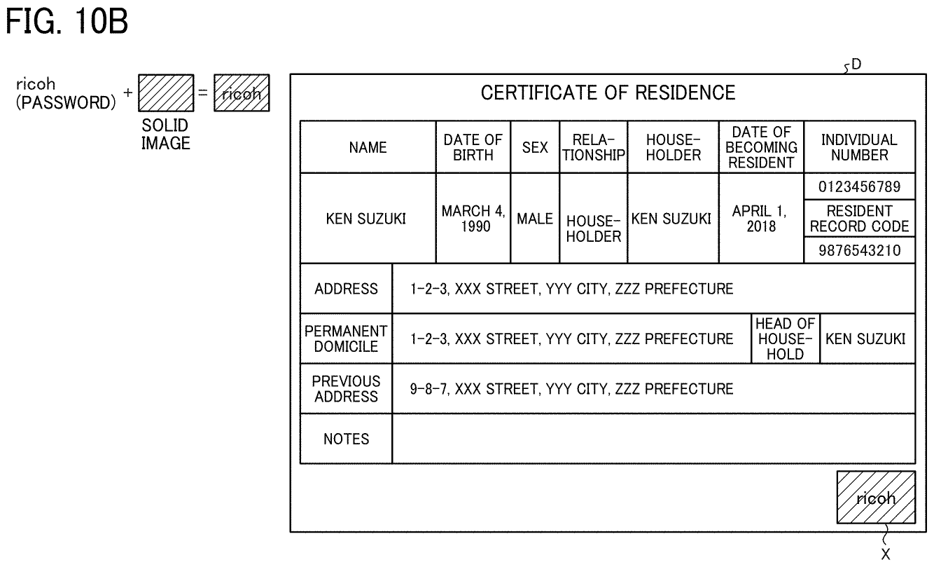

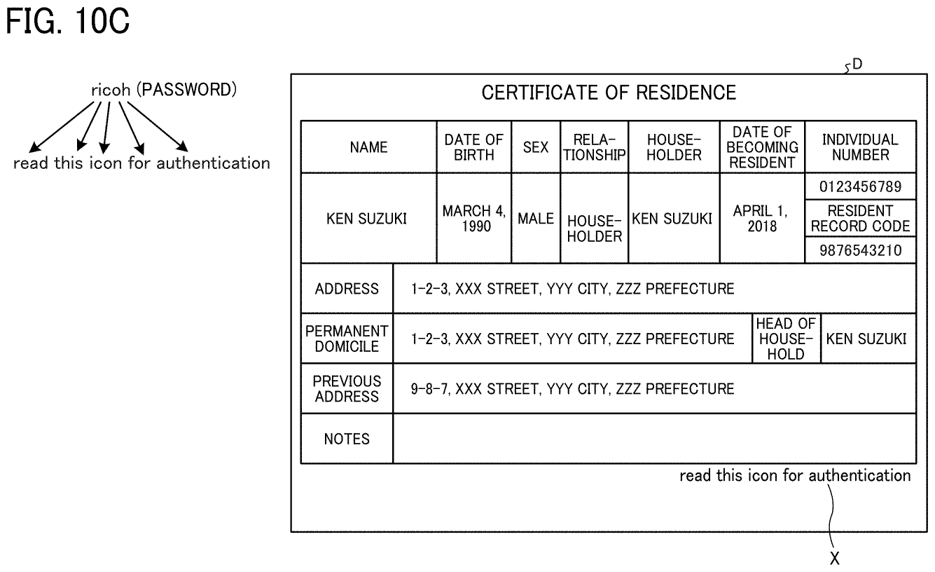

FIGS. 10A, 10B, and 10C are diagrams illustrating examples of setting the password as the authentication information.

For example, as illustrated in FIG. 10A, a two-dimensional code or a QR code may be generated from the password and embedded in the form D.

Further, as illustrated in FIG. 10B, a character string representing the password may be directly embedded in the form D and covered with a solid black image to make the character string of the password illegible. In this case, the character string of the password and the solid black image may be printed with the K toner and the YMC toner, respectively, to make the character string of the password legible with the invisible light source 2b. The solid image may be printed in a color other than black, as long as the password is made directly invisible with the color.

Further, as illustrated in FIG. 10C, another character string containing the characters of the character string of the password may be generated and embedded in the form D to conceal the password. In this case, the characters of the character string of the password and the other characters are printed with different types of toner so that the password is read with the visible light source 2a and the invisible light source 2b.

As described above, the password is previously set by the applicant for issuance of the form D at the time of issuance of the form D as the information for identifying the applicant, and is embedded in the form D as the embedded information X. The embedded information X is then used for authentication to further enhance the security strength.

Further, the authentication information may be generated from biometric information of the applicant for issuance of the form D and embedded in the form D as the embedded information X.

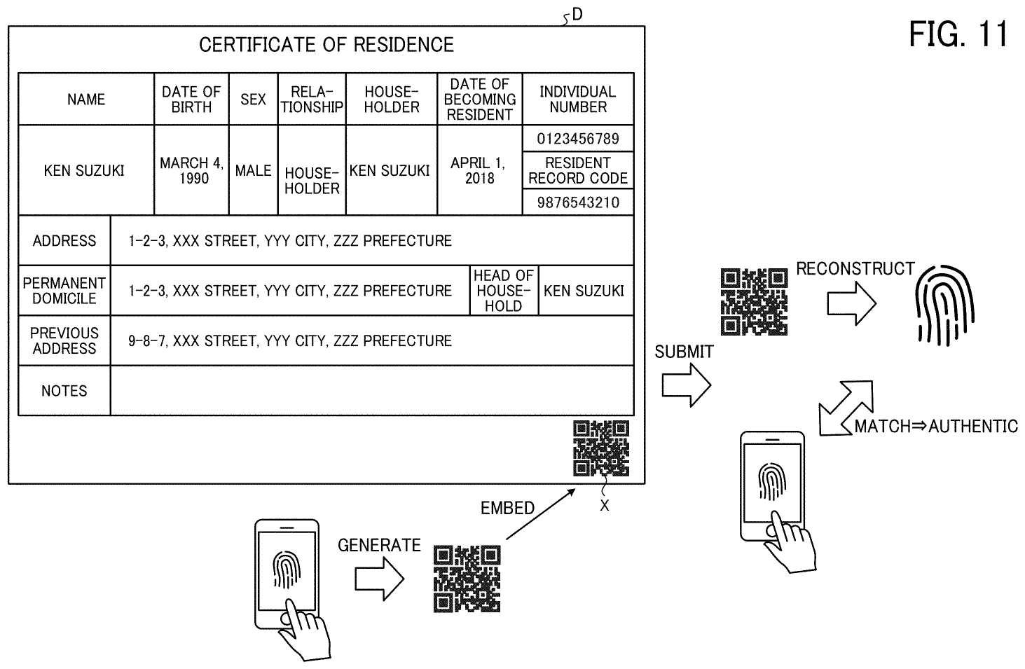

FIG. 11 is a diagram illustrating a method of generating the authentication information from the biometric information and executing authentication. The party that receives the form D generates the authentication information from biometric information of the submitter of the form D, and compares the generated authentication information with the authentication information embedded in the form D, as illustrated in FIG. 11. Alternatively, the party that receives the form D reconstructs the biometric information from the authentication information embedded in the form D as the embedded information X, and compares the reconstructed biometric information with the biometric information of the submitter of the form D to determine the authenticity of the submitted form D.

If the form D is not submitted by the applicant for issuance of the form D, therefore, the form D is not authenticated, thereby further enhancing the security strength.

The biometric information includes, but is not limited to, vein print, fingerprint, iris data, and voice print, for example. In the case of the fingerprint, for example, feature points such as a bifurcation point, an end point, a delta point, and a core point are extracted from the finger print and converted into a character string, for example, in accordance with a certain rule to generate the authentication information.

As described above with reference to FIGS. 10A to 10C, the authentication information generated from the biometric information may be a character string representing a password or an image representing a QR code. Further, the method of embedding the authentication information in the form D may be any embedding method. The character string may further be converted into a two-dimensional code or a QR code.

With the above-described authentication information, the form D should be submitted by the applicant for issuance of the form D. Further, the pattern of the authentication information to be generated is unknown even to the applicant for issuance of the form D, consequently further enhancing the security strength.

The above-described password setting is illustrative. Therefore, the password may be embedded in the form D in a different method.

As an example of the method of authenticating the form D, the party that receives the form D reconstructs the password by reading the form D in accordance with the embedding method of the embedded information X. Further, the party that receives the form D requests the submitter of the form D to present the password, and compares the presented password with the password reconstructed from the form D to determine the authenticity of the form D. In this case, if the password presented by the submitter of the form D does not match the password reconstructed from the form D, the party that receives the form D determines the submitted form D as having been inappropriately acquired by stealing or unauthorized copying, for example, and may refuse to accept the submitted form D or may request the submitter of the form D to submit a reissued form D, for example. The above-described authentication method is illustrative, and thus the authentication method is not limited thereto.

As described above, the information knowable only to the applicant for issuance of the form D is embedded in the form D as the authentication information in the form of the embedded information X. The present embodiment therefore compensates for the reduction in security strength due to non-use of light in the UV region or a special ink, thereby suppressing the reduction in security strength, and at the same time suppressing an increase in the application cost of the present embodiment or the difficulty in document preparation with the application of the present embodiment. Further, as described above with reference to FIGS. 10A to 10C, the present embodiment is applicable to various forms of authentication information, thereby enhancing the security strength.

Further, as information leading to the authentication process, uniform resource locator (URL) information may be embedded in the authentication information as the embedded information X. The URL information leads to an input form (e.g., an input form window) in which the password set by the applicant for issuance of the form D is to be input.

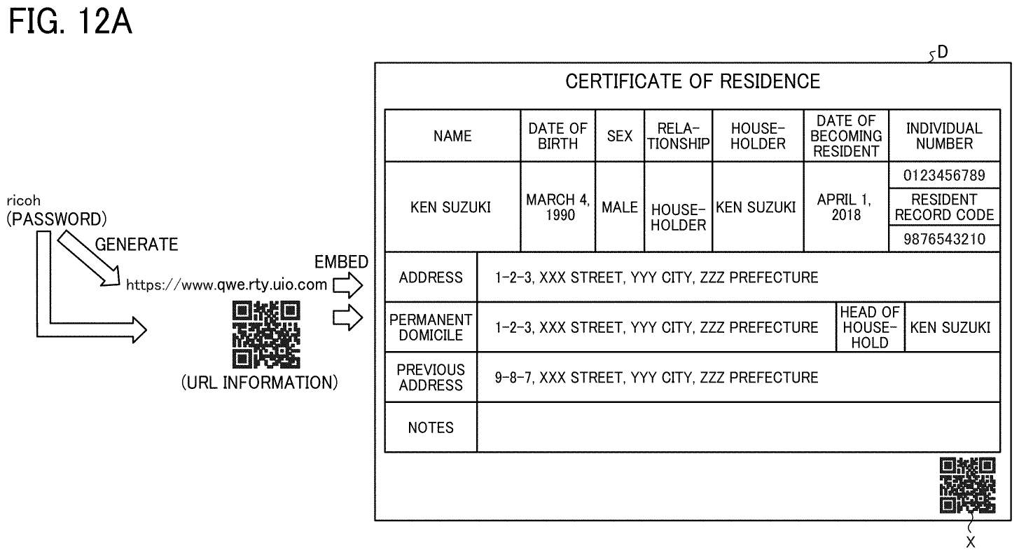

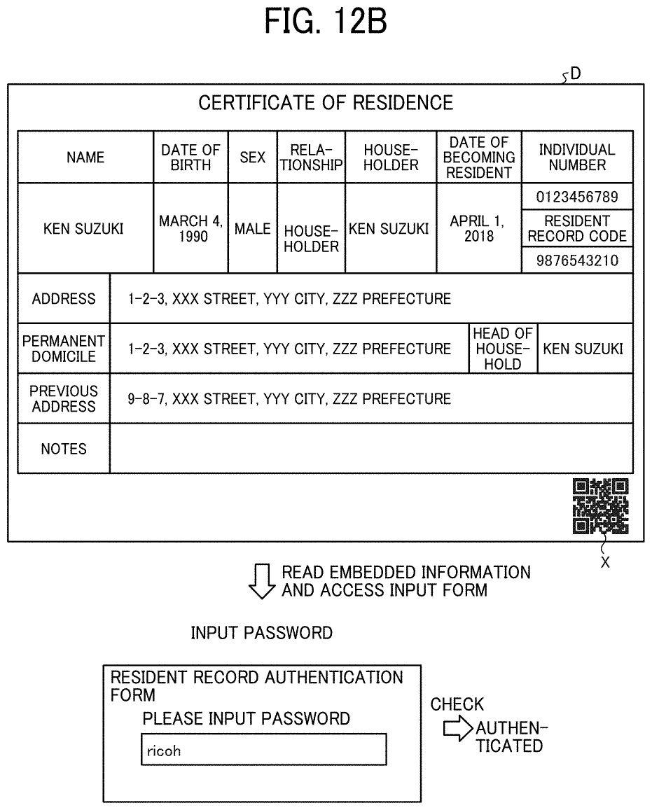

FIGS. 12A and 12B are diagrams illustrating a document authentication method using the embedding of information leading to the authentication process. FIG. 12A illustrates a procedure executed when issuing the form D. FIG. 12B illustrates a procedure executed when submitting the form D. As illustrated in FIG. 12A, the password input by the applicant for issuance of the form D at the location of the issuer of the form D may be associated with the input form, for example. Further, two different passwords may be input by the applicant for issuance of the form D at the time of issuance of the form D. Then, a URL for the input form may be generated from one of the two passwords, and the other password may be used in the authentication process, for example. That is, a plurality of passwords may be used in combination to lead to the authentication process. The embedding method to be employed here may be any method such as one of the methods described above with reference to FIGS. 10A to 10C.

As an example of the method of authenticating the form D, the party that receives the form D reads the form D in accordance with the embedding method of the embedded information X, and reconstructs the URL of the input form (e.g., an authentication form illustrated in FIG. 12B). The party that receives the form D further requests the submitter of the form D to present the password, and inputs the presented password to the input form to execute the authentication process.

In this case, if the password previously associated with the input form does not match the password input to the input form, the authentication process is completed with display of an error screen, for example. In this case, more than one retries may be allowed with password input errors taken into account. Then, if the authentication fails a predetermined number of times, the input form may be locked to block the use of the form D. In this case, the party that receives the form D determines the submitted form D as having been inappropriately acquired by stealing or unauthorized copying, for example, and may refuse to accept the submitted form D or may request the submitter of the form D to submit a reissued form D, for example.

According to the above-described authentication method based on the password input to the input form, it is unnecessary for a staff member of the party that receives the form D to execute the authentication process. If a reading device or terminal operable by the submitter of the form D is installed at the location of the form receiving party with instructions for the authentication procedure, the authentication process may be executed by the submitter of the form D.

Further, a system may be built which automatically generates an authentication number for each authenticated form D and requests the input of the authentication number of the form D to proceed with a procedure involving the submission of the form D. According to this system, the procedure will not proceed unless the form D is authenticated, thereby further enhancing the security strength. The authentication method described above is illustrative, and the authentication method is not limited thereto.

With the above-described authentication method, it is unnecessary to embed the authentication information per se in the form D, thereby reducing the risk of the authentication information in the form D being analyzed and abused.

As described above, the present embodiment enables the authentication of the form D with the authentication information printable with the Y toner, the M toner, the C toner, and the K toner stored in a typical image forming apparatus such as an MFP. The present embodiment therefore prevents the forgery of the form D with a simple structure, and suppresses an increase in the application cost of the present embodiment or the difficulty in the preparation of the form D with the application of the present embodiment.

Further, according to the present embodiment, the reading result obtained with the visible light source 2a and the reading result obtained with the invisible light source 2b are combined in accordance with a certain rule to generate the authentication information. Therefore, the authentication information is not easily forged, enhancing the security strength.

Further, according to the present embodiment, document forgery is prevented with a simple structure, i.e., a typical image forming apparatus such as an MFP equipped with an NIR light source, without a special light source that emits light in the UV region or special ink such as the IR black ink. The present embodiment therefore provides a reading device that suppresses an increase in application cost or difficulty in document preparation and improves the reproducibility and visibility of the document.

According to the combination rule illustrated in FIG. 8D, the authentication unit 52 simply subtracts the reading result obtained with the invisible light source 2b from the reading result obtained with the visible light source 2a. However, the combination rule is not limited thereto. Modified examples of the combination rule will be described below.

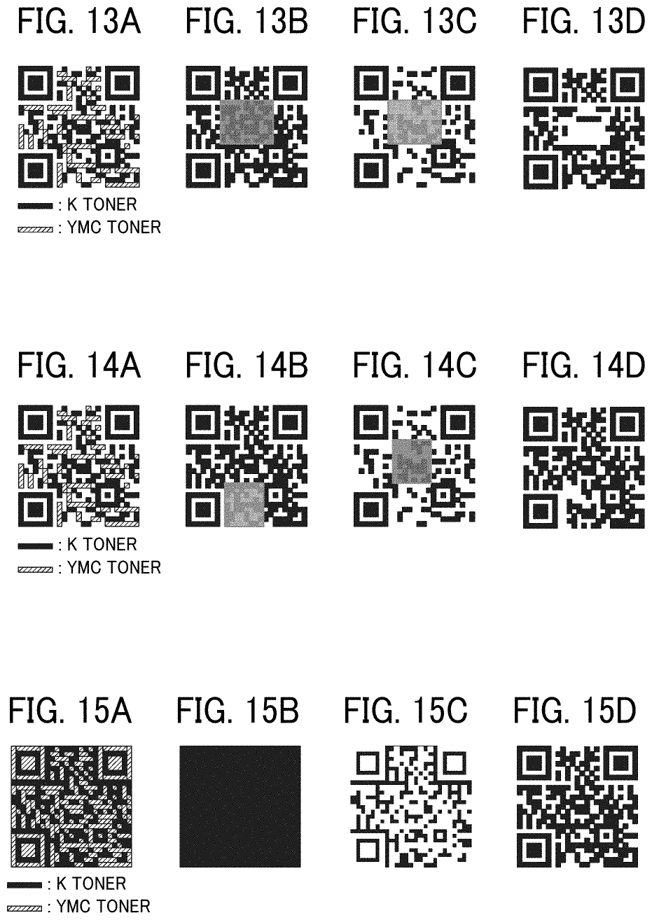

FIGS. 13A, 13B, 13C, and 13D are diagrams illustrating a first modified example of the combination rule. In the example illustrated in FIGS. 13A to 13D, the authentication unit 52 follows a combination rule that specifies a particular area in each of the image read with the visible light source 2a and the image read with the invisible light source 2b and combines the images in the particular area. FIG. 13A illustrates a print pattern of the authentication information. FIG. 13B illustrates a pattern read with the visible light source 2a. FIG. 13C illustrates a pattern read with the invisible light source 2b. FIG. 13D illustrates a pattern obtained by specifying a particular area in each of the patterns of FIGS. 13B and 13C and subtracting a portion of the black pattern of FIG. 13C included in the particular area from a portion of the black pattern of FIG. 13B included in the particular area.

According to the example of the combination rule illustrated in FIGS. 13A to 13D, a gray hatched area in each of FIGS. 13B and 13C is specified as the particular area, and the portion of the black pattern of FIG. 13C included in the particular area is subtracted from the portion of the black pattern of FIG. 13B included in the particular area. FIG. 13D illustrates the result of the subtraction.

In the example of the combination rule illustrated in FIGS. 13A to 13D, subtraction is used in the combination method. However, the combination method is not limited thereto, and may use a method other than subtraction.

In the example of the combination rule illustrated in FIGS. 13A to 13D, one area is specified as the particular area. However, the particular area is not limited thereto. A plurality of areas may be specified as the particular area. Further, the combination method may be changed for each area.

FIGS. 14A, 14B, 14C, and 14D are diagrams illustrating a second modified example of the combination rule. In the example illustrated in FIGS. 14A to 14D, the authentication unit 52 follows a combination rule that specifies a particular area in each of the image read with the visible light source 2a and the image read with the invisible light source 2b and replaces the images with each other in the particular area. FIG. 14A illustrates a print pattern of the authentication information. FIG. 14B illustrates a pattern read with the visible light source 2a. FIG. 14C illustrates a pattern read with the invisible light source 2b. FIG. 14D illustrates a pattern obtained by specifying a particular area in each of the patterns of FIGS. 14B and 14C and replacing a portion of the pattern of FIG. 14B included in the particular area with a portion of the pattern of FIG. 14C included in the particular area.

According to the example of the combination rule illustrated in FIGS. 14A to 14D, a gray hatched area in each of FIGS. 14B and 14C is specified as the particular area, and the portion of the pattern of FIG. 14B included in the particular area is replaced with the portion of the pattern of FIG. 14C included in the particular area. FIG. 14D illustrates the result of the replacement.

Alternatively, the portion of the pattern of FIG. 14C included in the particular area may be replaced with the portion of the pattern of FIG. 14B included in the particular area.

In the example of the combination rule illustrated in FIGS. 14A to 14D, one area is specified as the particular area. However, the particular area is not limited thereto. A plurality of areas may be specified as the particular area.

FIGS. 15A, 15B, 15C, and 15D are diagrams illustrating a third modified example of the combination rule. In the example illustrated in FIGS. 15A to 15D, the authentication unit 52 follows a combination rule that assigns a meaningless pattern to each of the image read with the visible light source 2a and the image read with the invisible light source 2b and combines the images to generate a meaningful pattern. FIG. 15A illustrates a print pattern of the authentication information. FIG. 15B illustrates a pattern read with the visible light source 2a. FIG. 15C illustrates a pattern read with the invisible light source 2b. FIG. 15D illustrates a pattern obtained by subtracting the pattern of FIG. 15C from the pattern of FIG. 15B.

As illustrated in FIG. 15A, when the print pattern printed with the K toner and the YMC toner is read with the visible light source 2a, a square solid black pattern illustrated in FIG. 15B is obtained.

When the print pattern printed with the K toner and the YMC toner is read with the invisible light source 2b, on the other hand, the pattern illustrated in FIG. 15C is obtained in which black and white of the QR code are reversed.

According to the example of the combination rule illustrated in FIGS. 15A to 15D, the pattern of FIG. 15C is subtracted from the pattern of FIG. 15B. FIG. 15D illustrates the result of the subtraction. With the pattern of FIG. 15C subtracted from the pattern of FIG. 15B, the QR code pattern illustrated in FIG. 15D appears.

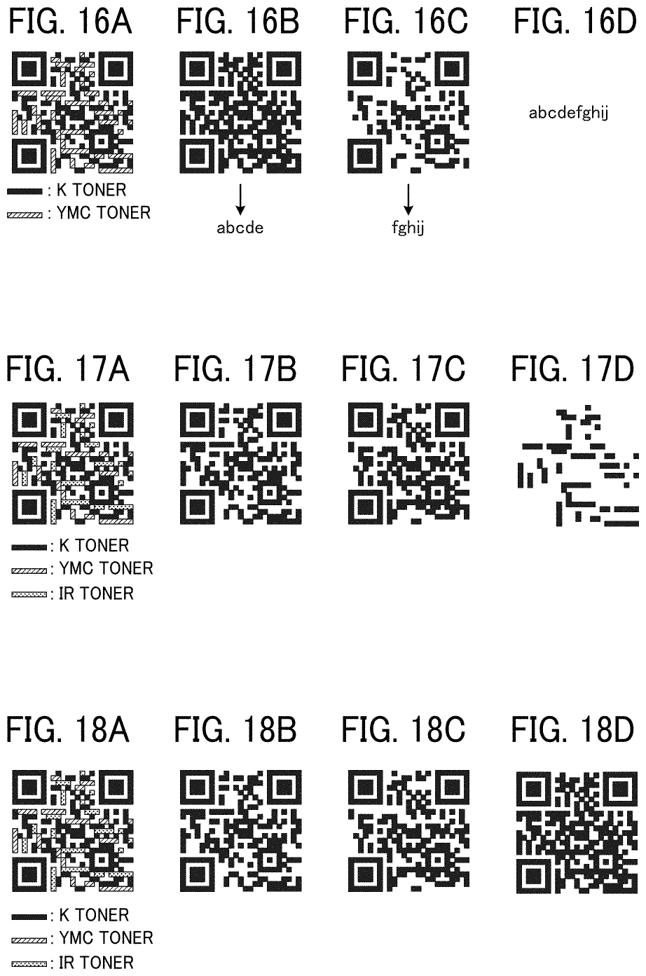

FIGS. 16A, 16B, 16C, and 16D are diagrams illustrating a fourth modified example of the combination rule. In the example illustrated in FIGS. 16A to 16D, the authentication unit 52 follows a combination rule that converts the respective images read with the visible light source 2a and the invisible light source 2b into respective character strings and combines the character strings. FIG. 16A illustrates a print pattern of the authentication information. FIG. 16B illustrates a character string converted from a pattern read with the visible light source 2a. FIG. 16C illustrates a character string converted from a pattern read with the invisible light source 2b. FIG. 16D illustrates a character string obtained by combining the character string of FIG. 16B and the character string of FIG. 16C.

For example, the image of FIG. 16B read with the visible light source 2a is converted into a character string “abcde,” and the image of FIG. 16C read with the invisible light source 2b is converted into a character string “fghij.” Then, the two character strings “abcde” and “fghij” are combined to generate a character string “abcdefghij” as the authentication information, as illustrated in FIG. 16D.

The example of the combination rule illustrated in FIGS. 16A to 16D simply connects the character strings. However, the method of combining the character strings is not limited thereto. As another example of the combination method, characters may be alternately extracted from the character strings and arranged sequentially, in alphabetical order, or in syllabary order of a certain language, for example.

Further, the authentication unit 52 may convert the respective images read with the visible light source 2a and the invisible light source 2b into respective numerical strings, perform an arithmetic operation with the numerical strings, and use the result of the arithmetic operation as the authentication information.

A second embodiment of the present invention will be described.

In the first embodiment, a description has been given of a method of authenticating the form D with the authentication information printed with the YMC toner and the K toner. In the second embodiment, the YMC toner and the K toner are further combined with invisible toner having absorption characteristics in the invisible light wavelength region. With the YMC toner and the K toner thus combined with the invisible toner, the security strength is further enhanced. In the following description of the second embodiment, a description of the same components as those in the first embodiment will be omitted, and the description will focus on differences from the first embodiment.

The invisible toner may be produced with a change in pigment forming a typical type of toner. In the second embodiment, IR toner having an absorption wavelength in the IR region will be described as an example of the invisible toner.

FIGS. 17A, 17B, 17C, and 17D are diagrams illustrating a reading example of a print pattern of the second embodiment using three types of toner. FIG. 17A illustrates a print pattern of the authentication information. FIG. 17B illustrates a pattern read with the visible light source 2a. FIG. 17C illustrates a pattern read with the invisible light source 2b. FIG. 17D illustrates the exclusive OR of the data of the pattern of FIG. 17B and the data of the pattern of FIG. 17C.

As illustrated in FIG. 17A, the print pattern of the authentication information is generated with a transparent pattern using the IR toner, as well as the black pattern using the K toner and the black pattern using the YMC toner, for example.

When reading the embedded information X (i.e., the print pattern) printed with the K toner, the YMC toner, and the IR toner, such as the print pattern illustrated in FIG. 17A, the image reading device 101 of the second embodiment sequentially selects the visible light source 2a and the invisible light source 2b with the light emitting device selection unit 51. With the print pattern thus read in the visible light condition and the invisible light condition, respectively, the image illustrated in FIG. 17B and the image illustrated in FIG. 17C are read.

As illustrated in FIG. 17B, in the wavelength region of the visible light source 2a, the black pattern using the YMC toner and the black pattern using the K toner are read. Further, as illustrated in FIG. 17C, in the wavelength region of the invisible light source 2b, the black pattern using the K toner and the transparent pattern using the IR toner are read.

These two images are then combined in accordance with a certain rule, as illustrated in FIG. 17D. In the example illustrated in FIG. 17D, the exclusive OR of the image data read with the visible light source 2a and the image data read with the invisible light source 2b is calculated and used as the authentication information.

According to the second embodiment, the black pattern using the K toner and the black pattern using the YMC toner are thus combined with the transparent pattern using the invisible toner. Thereby, variations of the print pattern of the authentication information are increased, enhancing the security strength.

A typical MFP used nowadays in an office environment is often designed to store four types (colors) of toner: the Y toner, the M toner, the C toner, and the K toner. Therefore, it may be difficult for such an MFP to simultaneously store five types of toner including the IR toner. For example, therefore, one of the Y toner, the M toner, and the C toner or the K toner may be replaced with the IR toner to combine the black pattern using the K toner or the black pattern using the YMC toner with the transparent pattern using the IR toner. Thereby, the authentication information using the IR toner is generated with a simple structure. Further, an MFP storing the IR toner may be prepared separately from an MFP storing the Y toner, the M toner, the C toner, and the K toner such that one of the MFPs prints a pattern with the Y toner, the M toner, the C toner, and the K toner and then the other MFP prints a pattern with the IR toner. Thereby, the authentication information using a combination of five types of toner is generated with a relatively simple structure.

Although FIGS. 17A to 17D illustrate the QR code for illustration, the actual print pattern is not limited thereto, and may be a two-dimensional code, a character string, or an image pattern, for example.

According to the combination rule illustrated in FIG. 17D, the authentication unit 52 calculates the exclusive OR of the reading result obtained with the visible light source 2a and the reading result obtained with the invisible light source 2b. However, the combination rule is not limited thereto. For example, the authentication unit 52 may also apply one of the combination rules illustrated in FIGS. 13A to 13D to FIGS. 16A to 16D to the example using three types of toner.

Further, in addition to the reading with the visible light and the reading with the invisible light described above, the light emitting device selection unit 51 of the second embodiment may also select simultaneous reading with the visible light and the invisible light.

FIGS. 18A, 18B, 18C, and 18D are diagrams illustrating an example of the simultaneous reading with the visible light and the invisible light. FIG. 18A illustrates a print pattern of the authentication information. FIG. 18B illustrates a pattern read with the visible light source 2a. FIG. 18C illustrates a pattern read with the invisible light source 2b. FIG. 18D illustrates a pattern obtained through the simultaneous reading with the visible light source 2a and the invisible light source 2b.

As illustrated in FIG. 18A, the print pattern is generated with the transparent pattern using the IR toner, as well as the black pattern using the K toner and the black pattern using the YMC toner, for example.

When reading the embedded information X (i.e., the print pattern) printed with the K toner, the YMC toner, and the IR toner, such as the print pattern illustrated in FIG. 18A, the image reading device 101 of the second embodiment sequentially selects the visible light source 2a and the invisible light source 2b and then simultaneously selects the visible light source 2a and the invisible light source 2b with the light emitting device selection unit 51.

As illustrated in FIG. 18B, in the wavelength region of the visible light source 2a, the black pattern using the YMC toner and the black pattern using the K toner are read. Further, as illustrated in FIG. 18C, in the wavelength region of the invisible light source 2b, the black pattern using the K toner and the transparent pattern using the IR toner are read. Further, as illustrated in FIG. 18D, in the simultaneous reading with the visible light source 2a and the invisible light source 2b, the black pattern using the YMC toner, the black pattern using the K toner, and the transparent pattern using the IR toner are read.

The above-described reading process enables the pattern obtained through the simultaneous reading with the visible light source 2a and the invisible light source 2b to be used as different types of data, i.e., as the pattern read with the visible light source 2a and the pattern read with the invisible light source 2b, in later image processing. That is, two types of data are obtainable in one simultaneous reading operation with the visible light source 2a and the invisible light source 2b, whereas a typical reading process involves two reading operations: the reading with the visible light source 2a and the reading with the invisible light source 2b. Consequently, the productivity is improved.

In the above-described simultaneous reading with the visible light source 2a and the invisible light source 2b, the black pattern using the YMC toner is read as a black image with the visible light, and is read as a white image with the NIR light. Therefore, the black pattern using the YMC toner is actually read as a gray image slightly lower in density than the original black image. For example, therefore, if an image expressed in two colors of white and black is simultaneously read with the visible light source 2a and the invisible light source 2b, the image is read as a pattern image in three colors of white, gray and black With this feature of the simultaneous reading applied to the authentication method, the security strength is further enhanced.

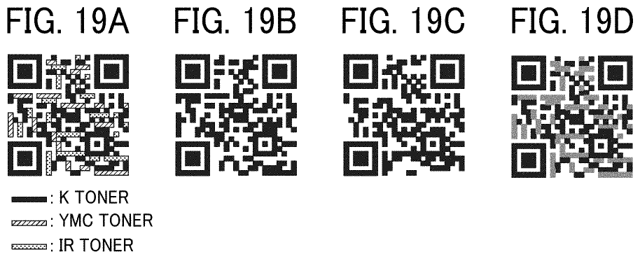

FIGS. 19A, 19B, 19C, and 19D are diagrams illustrating an example of using the three-color pattern in the simultaneous reading with the visible light and the invisible light.

FIG. 19A illustrates a print pattern of the authentication information. FIG. 19B illustrates a pattern read with the visible light source 2a. FIG. 19C illustrates a pattern read with the invisible light source 2b. FIG. 19D illustrates a pattern obtained through the simultaneous reading with the visible light source 2a and the invisible light source 2b.

As illustrated in FIG. 19A, the print pattern is generated with the transparent pattern using the IR toner, as well as the black pattern using the K toner and the black pattern using the YMC toner, for example.

When reading the embedded information X (i.e., the print pattern) printed with the K toner, the YMC toner, and the IR toner, such as the print pattern illustrated in FIG. 19A, the image reading device 101 of the second embodiment sequentially selects the visible light source 2a and the invisible light source 2b and then simultaneously selects the visible light source 2a and the invisible light source 2b with the light emitting device selection unit 51.

As illustrated in FIG. 19B, in the wavelength region of the visible light source 2a, the black pattern using the YMC toner and the black pattern using the K toner are read. Further, as illustrated in FIG. 19C, in the wavelength region of the invisible light source 2b, the black pattern using the K toner and the transparent pattern using the IR toner are read. Further, as illustrated in FIG. 19D, in the simultaneous reading with the visible light source 2a and the invisible light source 2b, the black pattern using the YMC toner, the black pattern using the K toner, and the transparent pattern using the IR toner are read.

For example, the authentication unit 52 follows a combination rule that determines the area ratio between black and gray in association with the set authentication information and determines the pattern of the embedded information X to be read with the visible light source 2a and the invisible light source 2b in accordance with the area ratio. In the authentication process, the authentication unit 52 determines, as well as the authenticity of the authentication information per se, whether the area ratio between black and gray of the read pattern matches the area ratio associated with the authentication information.

As a rule for determining the area ratio, the area ratio may be determined based on the number of characters or strokes included in the set password, the number of characters included in an initial part of the password before a shift in characters, or the number of characters included in the initial part of the password and the number of characters included in the rest part of the password, for example. For instance, in the setting of a password “AAAAA20190426,” the area ratio between black and gray may be determined as 13:87 based on the fact that the number of characters included in the whole password is 13. Further, the area ratio between black and gray may be determined as 6:4 based on the fact that the shift from alphabets to numbers occurs at the sixth character. Further, the area ratio between black and gray may be determined as 5:8 based on the fact that the password includes five alphabets and eight numbers. If this rule is changed on a regular basis, the security strength is further enhanced. The above-described examples of the rule are illustrative, and thus any other rule may also be employed.

Further, the above-described method using three colors is also illustrative, and any other method may also be employed.

The above-described second embodiment increases variations of the authentication method, further enhancing the security strength.

A third embodiment of the present invention will be described.

Visibly printed authentication information may be decoded from printed information. In the third embodiment, therefore, a dummy information pattern is printed separately from the authentication information. With dummy information thus embedded in a document separately from the information for authentication, the security strength is enhanced. In the following description of the third embodiment, a description of the same components as those in the first or second embodiment will be omitted, and the description will focus on differences from the first or second embodiment.

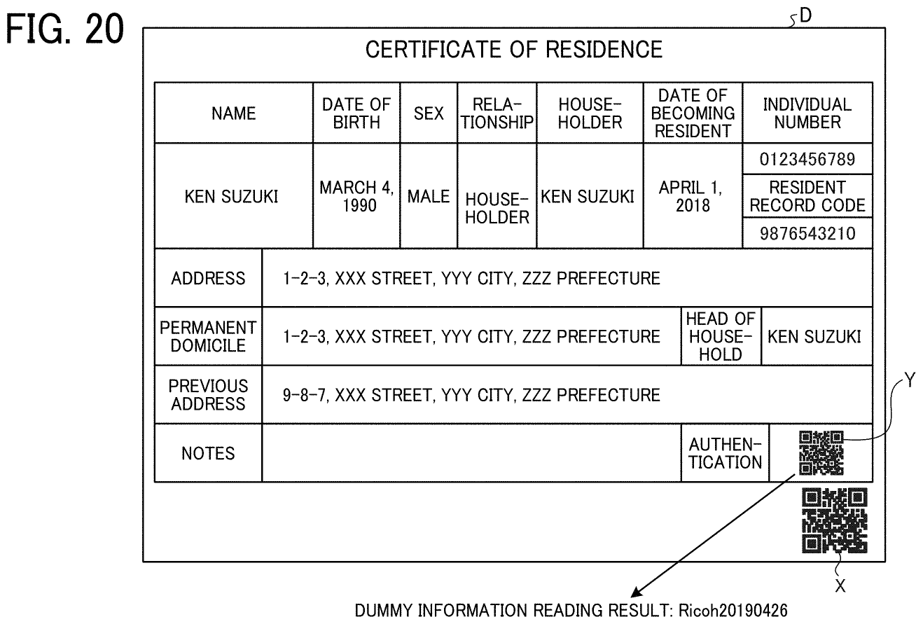

FIG. 20 is a diagram illustrating an example of the form D including dummy information Y of the third embodiment. As illustrated in FIG. 20, the form D includes a pattern of the dummy information Y. The dummy information Y should not be easily guessable as a dummy. For example, if the reading result of the dummy information Y is a meaningful word or a sentence combining a plurality of words rather than a random character string, the reading result looks more like a password. A character string with at least a certain number of characters including upper-case characters, lower-case characters, alphabetical characters, and numeric characters or a combination of a character string appearing to represent the name of a person and 4- or 8-digit numbers appearing to represent a birthday, for example, is effective in making the reading result of the dummy information Y look like a password. Further, as another method of making the dummy information Y look like authentic information, the dummy information Y may be printed in a field of the form D created between lines of the form D and titled “AUTHENTICATION,” for example.

A procedure of the authentication process using the above-described dummy information Y may also be designed to make the dummy information Y look like authentic information. For example, an initial part of the authentication process using the dummy information Y may be executed in a procedure similar to the procedure of the authentication process using the authentic embedded information X (hereinafter referred to as the regular authentication procedure).

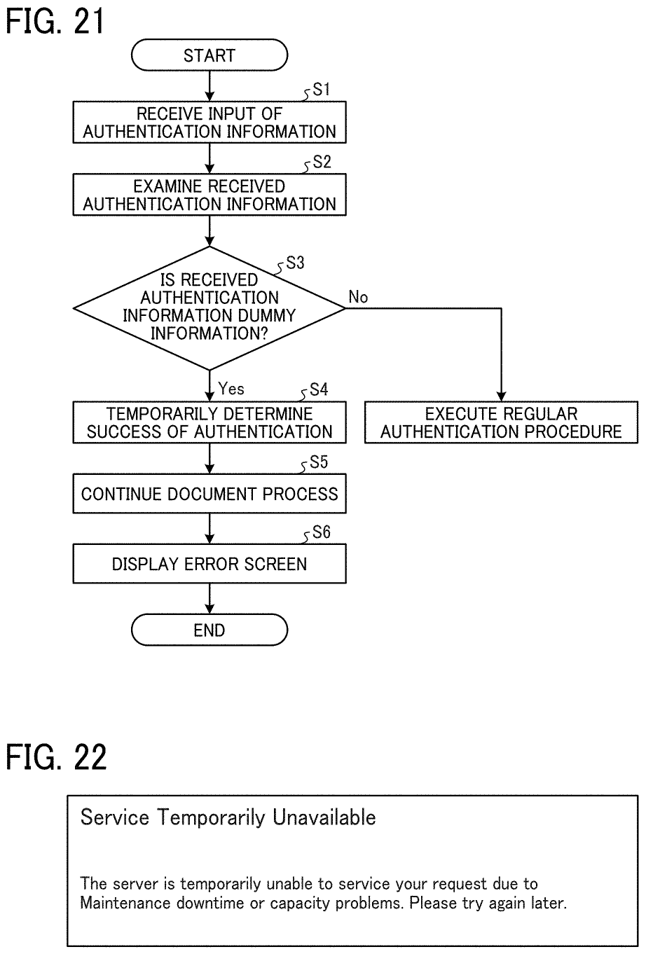

FIG. 21 is a flowchart illustrating a procedure of the authentication process using the dummy information Y As illustrated in FIG. 21, when a document process starts, the authentication unit 52 receives input of the authentication information (step S1), and examines the received authentication information (step S2).

If it is determined in the examination of the received authentication information that the authentication information is not the dummy information Y (No at step S3), the authentication unit 52 executes the regular authentication procedure.

If it is determined in the examination of the received authentication information that the authentication information is the dummy information Y (Yes at step S3), the authentication unit 52 temporarily determines the success of the authentication (step S4), continues the procedure of the document process (step S5), and then displays an error screen (step S6).

With the authentication process thus stopped or terminated halfway through the procedure, as illustrated in FIG. 21, it is possible to make the submitter of the form D believe that the submitted information is authentic but that the failure to complete the authentication process is due to a reason other than the authenticity of information.

FIG. 22 is a diagram illustrating a display example of the error screen. As illustrated in FIG. 22, when the authentication process is stopped or terminated halfway through the procedure, the authentication unit 52 may display, on a display of the image processing apparatus 100, an error screen with a message such as “NETWORK ERROR” or “THE PAGE IS BUSY,” which often appears on typical websites. Then, the authentication unit 52 forcefully terminates the procedure of the authentication process to make the submitter of the form D believe that the error is temporary.

The third embodiment thus reduces the risk of the authentication information being decoded.

A fourth embodiment of the present invention will be described.

In the third embodiment, the dummy image disguised as the image for authentication is prepared separately from the image for authentication. To reduce a space for printing the dummy image to provide enough space for printing the information of the form D, the fourth embodiment uses a print pattern in which each of the black pattern using the K toner, the black pattern using the YMC toner, and the transparent pattern using the IR toner independently functions. Thereby, the information printed with each of the above-described types of toner serves as independently meaningful information. It is therefore possible to embed a plurality of authentication information items in one space and enhance the security strength.

In the following description of the fourth embodiment, a description of the same components as those in any of the first to third embodiments will be omitted, and the description will focus on differences from the first to third embodiments.

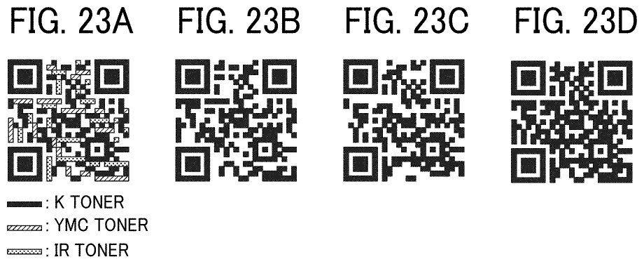

FIGS. 23A, 23B, 23C, and 23D are diagrams illustrating a reading example of a print pattern of the fourth embodiment. FIG. 23A illustrates a print pattern of the authentication information. FIG. 23B illustrates a pattern of the dummy information Y read with the visible light source 2a. FIG. 23C illustrates a pattern of the dummy information Y read with the invisible light source 2b. FIG. 23D illustrates a pattern of the authentication information obtained by combining the pattern read with the visible light source 2a and the pattern read with the invisible light source 2b.

As illustrated in FIG. 23A, the print pattern is generated with the transparent pattern using the IR toner, as well as the black pattern using the K toner and the black pattern using the YMC toner, for example.

When reading the embedded information X (i.e., the print pattern) printed with the K toner, the YMC toner, and the IR toner, such as the print pattern illustrated in FIG. 23A, the image reading device 101 of the fourth embodiment sequentially selects the visible light source 2a and the invisible light source 2b with the light emitting device selection unit 51. With the print pattern thus read in the visible light condition and the invisible light condition, respectively, the image illustrated in FIG. 23B and the image illustrated in FIG. 23C are read.

As illustrated in FIG. 23B, in the wavelength region of the visible light source 2a, the black pattern using the YMC toner and the black pattern using the K toner are read. Further, as illustrated in FIG. 23C, in the wavelength region of the invisible light source 2b, the black pattern using the K toner and the transparent pattern using the IR toner are read.

These two images are then combined in accordance with a certain rule, as illustrated in FIG. 23D. In the example illustrated in FIG. 23D, the authentication unit 52 combines the image data read with the visible light source 2a and the image data read with the invisible light source 2b, and assigns the function of the authentication information to the combined image data. The authentication unit 52 further assigns the function of the dummy information Y to the images illustrated in FIGS. 23B and 23C.

The dummy information Y is thus embedded in the form D to be superimposed on the authentication information for authentication, thereby reducing the space for printing the dummy information Y.

According to the fourth embodiment, the function of the dummy image is thus implemented in the space for printing the authentication information, obviating the need to prepare a separate space for printing the dummy image.

Further, according to the fourth embodiment, the dummy information Y and the authentication information are printed to be superimposed upon each other, and the function of the dummy information is assigned to the pattern read with a typical visible light source and the pattern read with an invisible light source that is implemented with relative ease. If the procedure of the authentication process using the dummy information Y, such as the procedure described above with reference to FIG. 21, is applied to the fourth embodiment, it is possible to make the submitter of the form D believe that the authentication process is normally proceeding, distracting the submitter of the form D from suspecting the existence of the dummy information Y.

In the above-described examples of the foregoing embodiments, an image processing apparatus of the present invention is applied to an MFP having at least two functions out of the copier function, the printer function, the scanner function, and the facsimile machine function. An image processing apparatus of the present invention, however, is applicable to any image forming apparatus such as a copier, a printer, a scanner, or a facsimile machine, for example.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An authentication apparatus comprising circuitry configured to
select at least one of a first light emitting device and a second light emitting device, the first light emitting device emitting light in a certain wavelength region, and the second light emitting device emitting light in a wavelength region different from the certain wavelength region of the light emitted from the first light emitting device, and
read embedded information based on a reading result obtained in an imaging device that receives the light emitted from the selected at least one of the first light emitting device and the second light emitting device and reflected by an authentication medium, the embedded information including information for authentication, and being embedded in the authentication medium and obtained with light in a range of light receiving sensitivity of silicon forming the imaging device.

2. The authentication apparatus of claim 1, wherein the first light emitting device emits light mostly in a visible wavelength region, and
wherein the second light emitting device emits light in a near-infrared wavelength region.

3. The authentication apparatus of claim 1, wherein the circuitry simultaneously selects the first light emitting device and the second light emitting device.

4. The authentication apparatus of claim 3, wherein the circuitry uses, as the reading result, an image having at least three different densities, the image being obtained through simultaneous reading with the first light emitting device and the second light emitting device.

5. An authentication system comprising:
a first light emitting device configured to emit light in a certain wavelength region;
a second light emitting device configured to emit light in a wavelength region different from the certain wavelength region of the light emitted from the first light emitting device; and
circuitry configured to
select at least one of the first light emitting device and the second light emitting device, and
read embedded information based on a reading result obtained in an imaging device that receives the light emitted from the selected at least one of the first light emitting device and the second light emitting device and reflected by an authentication medium, the embedded information including information for authentication, and being embedded in the authentication medium and obtained with light in a range of light receiving sensitivity of silicon forming the imaging device.

6. The authentication system of claim 5, wherein the embedded information is printed on the authentication medium with a combination of black visible toner and visible toner of a certain chromatic color,
wherein the first light emitting device irradiates the imaging device with light reflected by the black visible toner and light reflected by the visible toner of the certain chromatic color, and
wherein the second light emitting device irradiates the imaging device with the light reflected by the black visible toner.

7. The authentication system of claim 5, wherein the embedded information is printed on the authentication medium with at least one of black visible toner, visible toner of a certain chromatic color, and invisible toner that absorbs light in an invisible wavelength region,
wherein the first light emitting device irradiates the imaging device with light reflected by the black visible toner and light reflected by the visible toner of the certain chromatic color, and
wherein the second light emitting device irradiates the imaging device with the light reflected by the black visible toner.

8. The authentication system of claim 7, wherein the embedded information printed on the authentication medium includes first information printed with the black visible toner, second information printed with the visible toner of the certain chromatic color, and third information printed with the invisible toner that absorbs the light in the invisible wavelength region, the first information, the second information, and the third information each being independently meaningful information.

9. The authentication system of claim 5, wherein the embedded information includes, separately from the information for authentication, dummy information readable with at least one of the first light emitting device and the second light emitting device.

10. The authentication system of claim 9, wherein the dummy information is embedded in the authentication medium to be superimposed on the information for authentication.

11. The authentication system of claim 5, wherein the information for authentication is information for identifying an individual.

12. The authentication system of claim 11, wherein the information for identifying an individual is a password previously set by an applicant for issuance of the authentication medium.

13. The authentication system of claim 11, wherein the information for identifying an individual is generated from biometric information of an applicant for issuance of the authentication medium, and
wherein, in response to submission of the authentication medium, the circuitry
acquires the information for authentication from biometric information of a submitter of the authentication medium, or
reconstructs the biometric information of the applicant for issuance of the authentication medium from the information for authentication embedded in the authentication medium, and compares the reconstructed biometric information with the biometric information of the submitter of the authentication medium.

14. The authentication system of claim 11, wherein the information for authentication includes uniform resource locator information leading to an input form in which a password set by an applicant for issuance of the authentication medium is to be input.

15. An image processing system comprising:
a first light emitting device configured to emit light in a certain wavelength region;
a second light emitting device configured to emit light in a wavelength region different from the certain wavelength region of the light emitted from the first light emitting device;
an imaging device configured to receive light reflected by an authentication medium; and
the authentication apparatus of claim 1.

16. An image processing system comprising:
an imaging device configured to receive light reflected by an authentication medium; and
the authentication system of claim 5.

17. An authentication method comprising:
selecting at least one of a first light emitting device and a second light emitting device, the first light emitting device emitting light in a certain wavelength region, and the second light emitting device emitting light in a wavelength region different from the certain wavelength region of the light emitted from the first light emitting device; and
reading embedded information based on a reading result obtained in an imaging device that receives the light emitted from the selected at least one of the first light emitting device and the second light emitting device and reflected from an authentication medium, the embedded information including information for authentication, and being embedded in the authentication medium and obtained with light in a range of light receiving sensitivity of silicon forming the imaging device.
